(19) United States
(12) Patent Application Publication
(10) Pub. No.: US 2007/0124824 A1
(43) Pub. Date: May 31, 2007

(54) System and method for geolocation by a distributed network of geolocation equipment

(75) Inventor: Jeffrey C. Chu, Los Altos, CA (US)

Correspondence Address: WHITE & CASE LLP;PATENT DEPARTMENT, 1155 AVENUE OF THE AMERICAS, NEW YORK, NY, 10036, US

(73) Assignee: Glowlink Communications Technology, Inc.

(21) Appl. No.: 11/273,960

(22) Filed: Nov. 14, 2005

(51) Int. Cl. G06F 11/00; G06F 15/16

(52) U.S. Cl. 726/34; 709/217; 705/59

(57) ABSTRACT

A system for distributed networking of geolocation equipment includes a plurality of sites having geolocation equipment, each instance of geolocation equipment being coupled to a network, and a service provider coupled to the network. In exchange for ownership and use of geolocation equipment provided by the service provider, an operator of the geolocation equipment allows the service provider to access to the geolocation equipment over the network for use in locating unknown transmitters.

### FIELD OF THE INVENTION

This invention generally relates to geolocation equipment, and relates more particularly to a system and method for distributed networking of geolocation equipment.

### BACKGROUND

Geolocation involves the process of identifying the location of an unknown radio transmitter on Earth using space-based satellites and Earth-based receiving stations. Geolocation is frequently used to locate emergency signals transmitted by ships or airplanes. Geolocation has also been employed to identify the location of unknown transmitters on Earth emitting signals interfering with satellite communications. The signal from the unknown transmitter is detected by at least two geostationary satellites. The satellites retransmit the unknown signal to a receiver at a known location. Since the unknown signal travels along different paths to the satellites, the retransmitted unknown signals arrive at the known receiver at different times. Geolocation uses this time delay and other measurements to determine the location of the unknown transmitter.

A prior art system for geolocation is shown in FIG. 1. Geostationary satellites 132 and 134 receive signal from an unknown transmitter 122 on the Earth 100 via signals paths 124 and 126. Satellites 132 and 134 retransmit the received signals. The retransmitted signals are received at antennas 142a and 142b. Antenna 142a is aimed at satellite 132 and thus receives the signal retransmitted by satellite 132 via signal path 144. Antenna 142b is aimed at satellite 134 and thus receives the signal retransmitted by satellite 134 via signal path 146. Thus antenna 142a and antenna 142b receive the signal transmitted by unknown transmitter 122 via two different paths. Antennas 142a and 142b thus receive the signal from the unknown transmitter at two different times. Antennas 142a and 142b are coupled to geolocation equipment 148, which uses the time difference of the signals received by antennas 142a and 142b and other measurements to determine the location of unknown transmitter 122. Examples of systems and methods for geolocation using a single installation of geolocation equipment are disclosed in U.S. Pat. No. 5,008,679 to Effland et al. and Geolocation of a Known Altitude Object from TDOA and FDOA Measurements, by K. C. Ho et al., IEEE Transactions on Aerospace and Electronic Systems, Vol. 33, No. 3, July 1997, pp. 770-783.

The satellite communications industry is experiencing a surge in demand for accurate, reliable, inexpensive, and flexible geolocation services. A number of factors are causing this increase in demand. First, the global demand for satellite-based communications is growing at a rapid pace. Coupled with the increase in the demand for satellite-based communications is the increase in the various ancillary services supporting satellite communications, including geolocation. Second, due to numerous technological advancements, the price for powerful ground-based transmitters has decreased markedly in recent years. As a result, the number and distribution of such ground-based transmitters has increased dramatically. Each ground-based transmitter has the capability and potential to transmit an interfering signal that needs to be geolocated. The global war on terror is also playing a role in the demand for geolocation services.

The prohibitive cost of geolocation equipment is a significant issue and weighs heavily against the growing demand for geolocation services. Geolocation equipment is highly complex and difficult to manufacture. As a result, each installation of geolocation equipment is extremely expensive, sometimes running as high as a million dollars per installation.

A customer in need of geolocation services gains access to such services typically in one of two ways. The customer may decide that its need for geolocation services is sufficiently great to warrant paying the substantial cost of the geolocation equipment. In this instance, the customer will purchase one or more installations of an entire geolocation system from a geolocation equipment manufacturer. At that point, as the owner of the geolocation system, the customer can geolocate with its purchased geolocation system without restriction. The obvious downside to this scenario is the substantial cost of the geolocation system.

Alternatively, the customer for geolocation services may determine that its need for geolocation services does not warrant purchasing an entire geolocation system. In this case, the customer will seek out the services of a geolocation service provider. A geolocation service provider typically owns and operates a geolocation system. The geolocation service provider sells geolocation services on an as-needed basis to any customer in need of geolocation services. There is a number of disadvantages associated with the use of a conventional geolocation service provider. First, the cost of purchasing geolocation services from a conventional geolocation service provider is still extremely expensive when considered in context. In addition, geolocation service providers typically charge the customer whether or not the attempt to geolocate was successful. Thus, a customer can make a significant expenditure on geolocation services and walk away without the geolocation information sought. Finally, because the geolocation service provider relies on its own installations of geolocation equipment, its ability to effectively geolocate is limited by the quality and location of its geolocation systems.

Therefore, there is a need for a system and method for geolocation that provides accurate, reliable, inexpensive, and flexible geolocation services.

### SUMMARY

It is an advantage of the present invention to widely distribute and interconnect a plurality of individual installations of geolocation equipment so that geolocation services can be provided accurately on a global basis.

It is another advantage of the present invention to allow a geolocation service provider access to a plurality of individual installations of geolocation equipment over a network.

It is another advantage of the present invention to allow dynamic assignment of geolocation equipment over a network to perform specific geolocation services.

It is another advantage of the present invention to lower the cost of providing geolocation services to customers without degrading the quality of the provided services.

It is another advantage of the present invention to decrease the failure rate of any specific geolocation to allow the geolocation service provider to charge for geolocation services only when a search has been successful and not charge when the search is unsuccessful.

These and other advantages are achieved by the present invention. In accordance with one embodiment of the invention, a system for geolocation using a distributed network of geolocation equipment is provided, including a plurality of sites having geolocation equipment, each instance of geolocation equipment being coupled to a network, and a geolocation network controller operated by a service provider coupled to the network. Each instance of geolocation equipment is configured to both operate independently and operate as part of the network of geolocation equipment. In exchange for ownership and use of geolocation equipment provided by the service provider, a customer allows the service provider to access the geolocation equipment over the network for use in locating unknown transmitters. The service provider uses the distributed network of geolocation equipment to provide geolocation services to customers that do not have their own geolocation equipment, or to customers who have their own geolocation equipment but elect to engage the service provider to locate an unknown transmitter.

### BRIEF DESCRIPTION OF THE DRAWINGS

FIG. 1 is a diagram of a prior art system for geolocation;

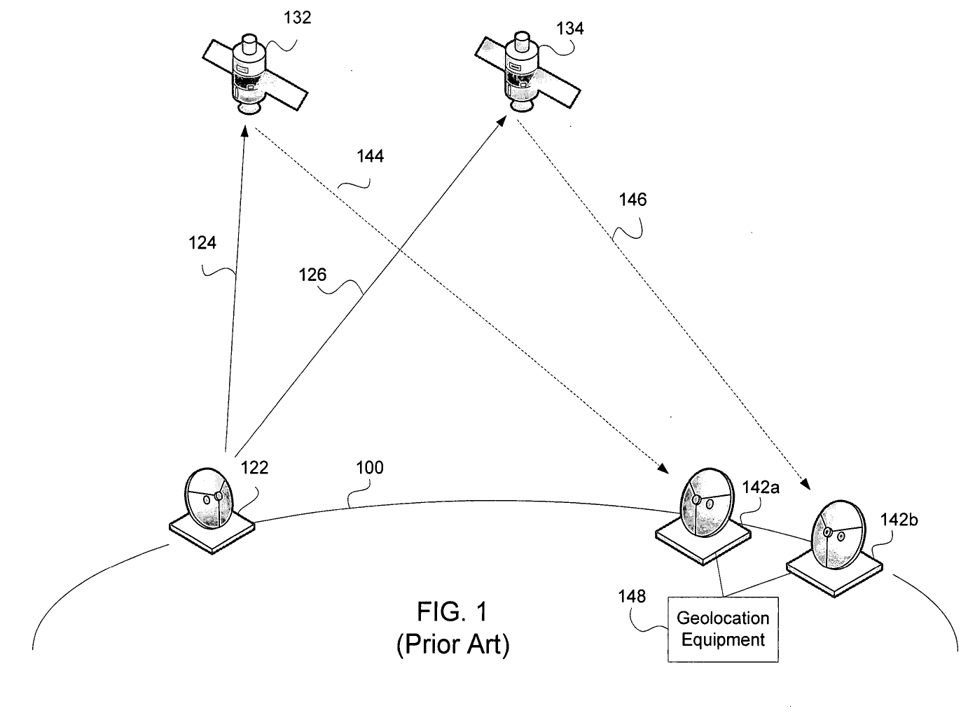

FIG. 2 is a block diagram of one embodiment of a distributed network of geolocation equipment, in accordance with the invention;

FIG. 3 is a block diagram of a preferred embodiment of a distributed network of geolocation equipment, in accordance with the invention; and

FIG. 4 is a flowchart of method steps for providing geolocation services using a distributed network of geolocation equipment, in accordance with one embodiment of the invention.

### DETAILED DESCRIPTION

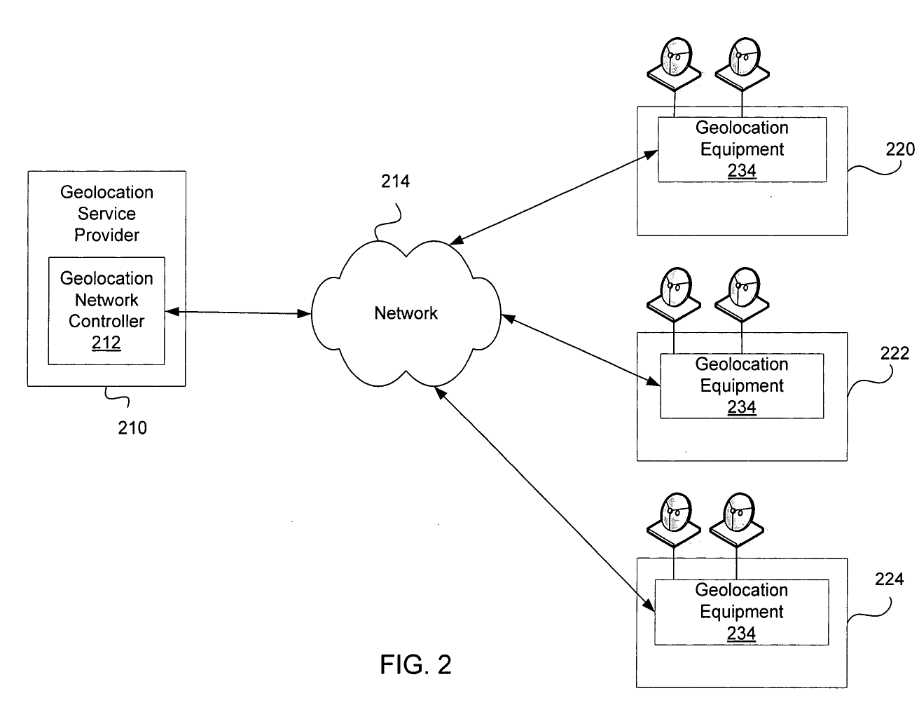

The present invention will now be described with reference to FIGS. 2-4 which in embodiments relate to a system and method for geolocation using a distributed network of geolocation equipment. It is understood that the present invention may be embodied in many different forms and should not be construed as being limited to the embodiments set forth herein. Rather, these embodiments are provided so that this disclosure will be thorough and complete and will fully convey the invention to those skilled in the art. Indeed, the invention is intended to cover alternatives, modifications and equivalents of these embodiments, which are included within the scope and spirit of the invention as defined by the appended claims. Furthermore, in the following detailed description of the present invention, numerous specific details are set forth in order to provide a thorough understanding of the present invention. However, it will be clear to those of ordinary skill in the art that the present invention may be practiced without such specific details.

The present invention contemplates establishing a large number of interconnected installations of geolocation equipment widely dispersed throughout the globe. The plurality of installations of geolocation equipment would be interconnected over a wide area network and accessible remotely by a geolocation service provider. To achieve this system in a cost effective manner, the present invention changes the manner in which geolocation equipment is provided to customers of geolocation services. Rather than selling geolocation equipment to the customers of geolocation services at the fair market value of the geolocation equipment, the geolocation equipment is provided to customers at a significantly reduced cost or even for free. At such a reduced cost, it is felt that the demand for geolocation equipment will increase significantly, thereby causing increased sales of geolocation equipment throughout the globe.

In exchange for providing the geolocation equipment at the significantly reduced cost, the equipment manufacturer or its agent would negotiate with the customers of the geolocation equipment the right to connect to the geolocation equipment through a network and the right to use the geolocation equipment over the network. Thus would be established the large number of interconnected installations of geolocation equipment widely dispersed throughout the globe. The equipment manufacturer or its agent can then use its access to the globally dispersed network of geolocation equipment to sell highly accurate, reliable, inexpensive, and flexible geolocation services.

FIG. 2 is a diagram of one embodiment of a distributed network of geolocation equipment according to the present invention. The distributed network includes, but is not limited to, a geolocation service provider 210, a communication network 214, and geolocation sites 220, 222, and 224. Geolocation service provider 210 includes, but is not limited to, a geolocation network controller 212. Each geolocation site 220, 222, and 224 includes, but is not limited to, geolocation equipment 234. Each instance of geolocation equipment 234 is coupled to network 214 and is configured to communicate with geolocation network controller 212. Network 214 may be implemented as any type of electronic network, for example a local area network, a wide area network, a wireless network, a virtual private network, the Internet, or a combination of any of these types of networks. Geolocation equipment 234 is coupled to at least two antennas for receiving signals from geostationary satellites, and includes hardware and software to perform geolocation methods to locate an unknown transmitter. Each instance of geolocation equipment 234 is configured to operate independently and to operate as part of a distributed network of geolocation equipment 234 to locate unknown transmitters. Although only three geolocation sites are shown in FIG. 2, any number of geolocation sites including geolocation equipment 234 is within the scope of the invention.

Geolocation service provider 210 can provide geolocation services by accessing geolocation equipment 234 via network 214 using geolocation network controller 212. Geolocation network controller 212 is configured to access and operate geolocation equipment 234 over network 214. Geolocation network controller 212 is able to select one or more of geolocation sites 220, 222, or 224 that will provide the best performance for the requested geolocation service, and to control the operation of the selected geolocation equipment 234 via network 214.

Each instance of geolocation equipment 234 is controlled by an operator (an individual or legal entity) other than geolocation service provider 210. In one embodiment, the operators of geolocation sites 220, 222, and 224 purchase, lease, or otherwise obtain control over an instance of geolocation equipment 234 from a vendor of geolocation equipment. The vendor of geolocation equipment may be geolocation service provider 210 or some other party. Each operator of geolocation sites 220, 222, and 224 enters into an access agreement with geolocation service provider 210 in which geolocation service provider 210 is allowed to access and operate geolocation equipment 234 via network 214 while the operator maintains some control over operating geolocation equipment 234.

In one embodiment, geolocation service provider 210 provides geolocation equipment 234 to the operators of geolocation sites 220, 222, and 224 at a less than fair market price. For example, geolocation service provider 210 may provide geolocation equipment 234 to the operators of geolocation sites 220, 222, and 224 at 100%, 50%, or 25% of the cost of geolocation equipment 234 or for free. In consideration of receiving geolocation equipment 234 at a less than fair market price, each of the operators of geolocation sites 220, 222, and 224 enters into an access agreement with geolocation service provider 210 that allows geolocation network controller 212 to access and operate geolocation equipment 234 via network 214 for little or no cost, while each operator maintains some control over geolocation equipment 234.

In one embodiment, the access agreement between geolocation service provider 210 and each of the operators of geolocation sites 220, 222, and 224 allows geolocation network controller 212 to access and operate geolocation equipment 234 at specified times for a specified duration. For example, an access agreement between geolocation service provider 210 and the operator of geolocation site 220 allows geolocation network controller 212 to access and operate geolocation equipment 234 every day at 6:00 am and 6:00 pm for a period of 1 hour.

In another embodiment, the access agreement between geolocation service provider 210 and each of the operators of geolocation sites 220, 222, and 224 allows geolocation network controller 212 to access and operate geolocation equipment 234 for a specified amount of time over a certain number of days. For example, an access agreement between geolocation service provider 210 and the operator of geolocation site 222 allows geolocation network controller 212 to access and operate geolocation equipment 234 at any time for a total of 12 hours every month.. Alternatively, geolocation network controller 212 may be allowed to access and operate geolocation equipment 234 for a total of 5 hours every week.

In another embodiment, the access agreement between geolocation service provider 210 and each of the operators of geolocation sites 220, 222, and 224 allows geolocation network controller 212 to access and operate geolocation equipment 234 only after approval of a request for access. For example, the access agreement between geolocation service provider 210 and the operator of geolocation site 224 requires geolocation network controller 212 to send a request for access to geolocation site 224 and the request to be approved by geolocation site 224 before geolocation network controller 212 is allowed to access and operate geolocation equipment 234. The request for access may be sent via network 214 to geolocation equipment 234, which is configured to determine whether to approve or reject the request based on a set of criteria. In one embodiment, this set of criteria includes a current load on geolocation equipment 234 and network congestion.

Geolocation service provider 210 may have a different type of access agreement with each of the operators of geolocation sites 220, 222, and 224 or may have a standard access agreement that it enters into with all operators of geolocation sites 220, 222, 224. The type of access agreement may depend on whether the operators of geolocation sites 220, 222, and 224 obtained geolocation equipment 234 from geolocation service provider 210 or some other vendor.

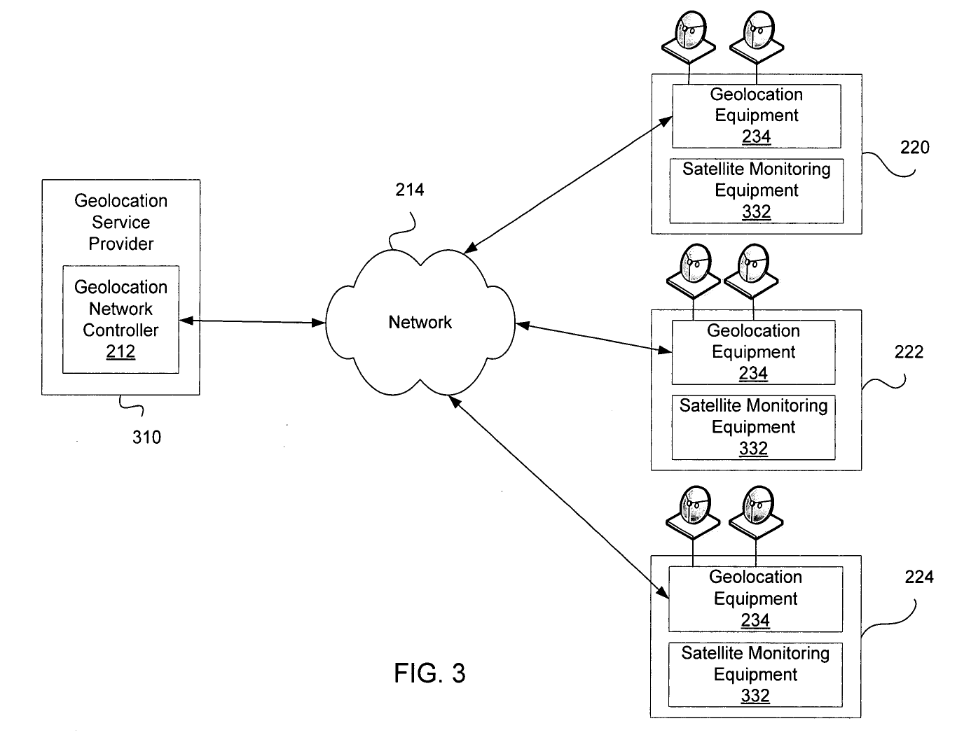

FIG. 3 is a block diagram of a preferred embodiment of the distributed network of geolocation equipment, in accordance with the invention. Geolocation service provider 310 is a vendor of satellite monitoring equipment 332 and geolocation equipment 234. Each instance of satellite monitoring equipment 332 is configured to monitor satellites affiliated with each of geolocation sites 220, 222, and 224. Geolocation service provider 310 sells satellite monitoring equipment 332 to the operators of geolocation sites 220, 222, and 224 for a fair market price. Geolocation service provider 310 also provides geolocation equipment 234 to the operators of geolocation sites 220, 222, and 224, but at a less than fair market price. For example, geolocation service provider 310 may provide geolocation equipment 234 to purchasers of satellite monitoring equipment 332 at 100%, 50%, or 25% of the cost of geolocation equipment 234 or for free. In consideration of receiving geolocation equipment 234 for less than the fair market price, each of the operators of geolocation sites 220, 222, and 224 enters into an access agreement with geolocation service provider 310 that allows geolocation network controller 212 to access and operate geolocation equipment 234 via network 214, while each operator maintains some control over geolocation equipment 234. Geolocation service provider 310 can utilize the distributed network of geolocation equipment 234 to provide geolocation services to other customers, particularly customers that do not have their own geolocation equipment. Geolocation network controller 212 can access and operate any one or more of instances of geolocation equipment 234 to provide geolocation services to other customers, who may or may not have their own geolocation equipment. Geolocation network controller can select the geolocation equipment 234 that will provide the best results for geolocation of an unknown transmitter.

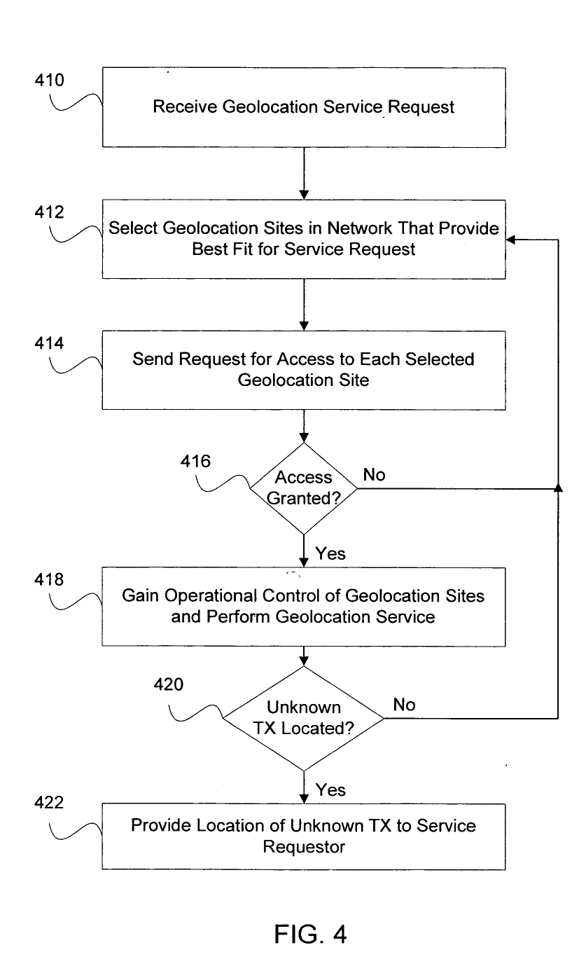

FIG. 4 is a flowchart of method steps for providing geolocation services using a distributed network of geolocation equipment, in accordance with one embodiment of the invention. In step 410, geolocation service provider 210 receives a geolocation service request to locate an unknown transmitter somewhere on the Earth. In one embodiment, the service requestor is an entity that does not have its own geolocation equipment. In step 412, geolocation network controller 212 performs a procedure to select one or more geolocation sites in a distributed network of geolocation equipment that provide the best fit for the service request. In step 414, geolocation network controller 212 sends a request for access to each of the selected geolocation sites. In step 416, geolocation network controller 212 determines if each geolocation site accepts or rejects the request for access. If the geolocation site accepts the request for access, the method continues with step 418. If the geolocation site refuses the request for access, the method returns to step 412 where geolocation network controller 212 notes that the refusing geolocation site is not available, and re-selects one or more geolocation sites.

In step 418, geolocation network controller 212 gains operational control over the one or more geolocation sites that accepted the request for access, and performs the requested geolocation service. In step 420, geolocation network controller 212 determines whether the unknown transmitter (TX) has been located. If the unknown transmitter has been located, then in step 422 geolocation service provider 210 provides the location of the unknown transmitter to the service requester. If the unknown transmitter has not been located, then the method returns to step 412 where geolocation network controller 212 notes that the previously selected geolocation sites did not provide the requested location, and re-selects one or more geolocation sites.

Although this invention has been disclosed in the context of certain preferred embodiments and examples, it will be understood by those skilled in the art that the present invention extends beyond the specifically-disclosed embodiments to other alternative embodiments and/or uses of the invention and obvious modifications and equivalents thereof. In addition, while a number of variations have been shown and described in detail, other modifications, which are within the scope of this invention, will be readily apparent to those of skill in the art based upon this disclosure. It is also contemplated that various combinations or subcombinations of the specific features and aspects of the embodiments may be made and still fall within the scope of the invention. Accordingly, it should be understood that various features and aspects of the disclosed embodiments can be combined with or substituted for one another in order to form varying modes of the disclosed system and method. Thus, it is intended that the scope of the present invention should not be limited by the particular disclosed embodiments described above, but should be determined only by a fair reading of the claims that follow.

What is claimed is:

1. A method for geolocation using a distributed network of geolocation equipment, comprising:
providing geolocation equipment to a customer, wherein the geolocation equipment is coupled to a network such that the geolocation equipment can be operated over the network;
transferring at least a portion of control over the geolocation equipment to the customer so that the customer is capable of operating the geolocation equipment to perform geolocation services on at least the customer's behalf; and
retaining for or transferring to an operator of geolocation equipment other than the customer at least a right to access the geolocation equipment over the network so that the operator is capable of operating the geolocation equipment to perform geolocation services.

2. The method of claim 1, wherein the step of providing geolocation equipment to a customer includes selling the geolocation equipment to the customer at a less than fair market price in exchange for access to the geolocation equipment via the network.

3. The method of claim 1, wherein the step of providing geolocation equipment to a customer includes providing the geolocation equipment to the customer for free in exchange for access to the geolocation equipment via the network.

4. The method of claim 1, further comprising providing satellite monitoring equipment to the customer.

5. The method of claim 1, wherein the operator is allowed to access and operate the geolocation equipment at specified times for a specified period.

6. The method of claim 1, wherein the operator is allowed to access and operate the geolocation equipment for a specified amount of time over a specified number of days.

7. The method of claim 1, wherein the operator is allowed to access and operate the geolocation equipment upon approval of a request for access.

8. A system for distributed networking of geolocation equipment, comprising:
geolocation equipment controlled at least in part by a first operator at the operator's premises, the geolocation equipment configured to operate independently and over a network; and
a geolocation network controller controlled by a second operator, the geolocation network controller coupled to the network;
wherein the second operator obtained at least a portion of the control over at least a portion of the geolocation equipment so that the second operator is capable of operating the geolocation equipment over the network.

9. The system of claim 8, wherein the second operator is a vender of geolocation equipment and sold the geolocation equipment to the first operator at a less than fair market price in exchange for the at least a portion of the control over at least a portion of the geolocation equipment.

10. The system of claim 8, wherein the second operator is a vendor of geolocation equipment and provided the geolocation equipment to the first operator for free in exchange for the at least a portion of the control over at least a portion of the geolocation equipment.

11. The system of claim 8, wherein the second operator provides geolocation services by accessing and operating the geolocation equipment via the network.

12. The system of claim 8, wherein the second operator is a vendor of geolocation equipment and satellite monitoring equipment, and the first operator controls satellite monitoring equipment obtained from the second operator.

13. The system of claim 8, wherein the geolocation network controller is allowed to access and operate the geolocation equipment at specified times for a specified period.

14. The system of claim 8, wherein the geolocation network controller is allowed to access and operate the geolocation equipment for a specified amount of time over a specified number of days.

15. The system of claim 8, wherein the geolocation network controller is allowed to access and operate the geolocation equipment upon approval of a request for access.

16. A method for providing geolocation services, comprising:
receiving a request for a geblocation service at a geolocation service provider;
selecting one or more instances of geolocation equipment in a distributed geolocation network, wherein at least one of the one or more instances of geolocation equipment is not wholly controlled by the geolocation service provider;
requesting access to each of the selected one or more instances of geolocation equipment;
if the request for access is granted, gaining operational control of the one or more instances of geolocation equipment and performing the requested geolocation service; and
if the request for access is denied, reselecting one or more instances of geolocation equipment in the distributed geolocation network.

17. The method of claim 16, wherein selecting one or more instances of geolocation equipment includes determining one or more instances of geolocation equipment that provide a best fit to the requested geolocation service.

18. The method of claim 16, wherein at least one of the one or more instances of geolocation equipment was purchased from the geolocation service provider by a customer.

19. The method of claim 16, wherein at least one of the one or more instances of geolocation equipment is configured to operate independently to perform a geolocation service and to operate over the network to perform a geolocation service.

20. The method of claim 16, wherein each of the one or more instances of geolocation equipment is not wholly controlled by the geolocation service provider.
